(19) United States
(12) Patent Application Publication
(10) Pub. No.: US 2004/0174355 A1
(43) Pub. Date: Sep. 9, 2004

(54) Signal line drive circuit in image display apparatus

(75) Inventors: Eiji Taguchi, Gifu-shi (JP); Shoichiro Matsumoto, Gifu-shi (JP)

Correspondence Address: McDERMOTT, WILL & EMERY, 600 13th Street, N.W., Washington, DC, 20005-3096, US

(73) Assignee: SANYO ELECTRIC CO., LTD.

(21) Appl. No.: 10/784,873

(22) Filed: Feb. 24, 2004

(30) Foreign Application Priority Data
Mar. 7, 2003 (JP) JP2003-061223

(51) Int. Cl. G09G 5/00

(52) U.S. Cl. 345/204

(57) ABSTRACT

The on-resistance of each of the respective switches in an upper selection circuit is adjusted according to a reference gradation voltage of a reference gradation voltage line, to which each switch is connected, and a dividing resistance of a ladder resistance. A circuit configuration for the upper selection circuit and lower selection circuit is structured by the combination of an external logic type circuit and an internal logic type circuit. Thus, the colors of an image display apparatus can be controlled smoothly.

### BACKGROUND OF THE INVENTION

1. Field of the Invention

The present invention relates to image display apparatus, and it particularly relates to designing the signal line drive circuits.

2. Description of the Related Art

In recent years, semiconductor devices with semiconductor thin film formed on glass substrate have come into wide use. In particular, the use of active matrix type image display apparatuses using TFTs (Thin Film Transistors) has been increasing markedly. And of late, advances are being made in polysilicon TFT technology whereby both TFTs, which constitute pixels, and drive circuits, which are located outside of the pixel-matrix are formed integrally on the same substrate. This technology can not only reduce the amount of wiring for an image display apparatus significantly but also realize improved durability, thinner size and lighter weight, and lower power consumption. Besides, the drive circuits thus formed integrally are not only types for analog image signals but also ones for digital image signals.

A typical example of an active matrix type image display apparatus is an active matrix liquid crystal display. The signal line drive circuit of an active matrix type liquid crystal display apparatus samples inputted image signals in synchronization with timing signals, such as clock signals. Then it converts the sampled image signals into predetermined corresponding voltages and apply them to the liquid crystals, which serve as the pixels. The liquid crystals can perform image display using their capacity to change the light transmittance according to the applied voltages.

Related Art List

(1) Japanese Patent Application Laid-Open No. Heill-167373.

A signal line drive circuit has, in general, a plurality of switches within it. Hence, in the process of its converting image signals into predetermined corresponding voltages, there occur voltage drops due to the on-resistance of such switches. And these voltage drops can sometimes cause differences between the voltages the signal line drive circuit attempts to apply to the respective pixels and the actual voltages applied thereto. This makes it difficult to control colors, especially those with multiple gradations.

### SUMMARY OF THE INVENTION

The present invention has been made in view of the foregoing circumstances and an object thereof is to provide a technology for smoothly controlling the colors of an image display apparatus.

A preferred embodiment according to the present invention relates to a signal line drive circuit. This circuit includes: a high-voltage side switch block and a low-voltage side switch block; a ladder resistor across which a high-voltage side voltage and a low-voltage side voltage are applied through a high-voltage side selection switch selected from the high-voltage side switch block and a low-voltage side selection switch selected from the low-voltage side switch block, respectively; and a plurality of intermediate voltage takeout signal lines which take out a first intermediate voltage from an end point, connected to the high-voltage side selection switch, of the ladder resistor and which then take out a second and a third, . . . and (k−1)th intermediate voltage from any other end points thereof in the order of closeness to the high-voltage side selection switch and which take out a kth intermediate voltage from an end point, connected to the low-voltage side selection switch, of the ladder resistor, where k is an integer greater than or equal to 2, wherein a dividing resistance value which causes a difference between the first intermediate voltage and the second intermediate voltage among resistance components in the ladder resistor is greater than an on-resistance value of the high-voltage side selection switch.

The “switch” is primarily an electronic device such as a transistor, but is not limited thereto, and may be any device which conducts and stops currents or switches them. The “switch block” is a generic name for a plurality of switches by which to select voltage applied to respective end points of the ladder resistors. The on-resistance value of the high-voltage side selection switch is made smaller than a high-voltage side dividing resistance value among the ladder resistors, so that the color of pixels can be controlled smoothly.

Another preferred embodiment according to the present invention relates also to a signal line drive circuit. This circuit includes: a high-voltage side switch block and a low-voltage side switch block; a ladder resistor across which a high-voltage side voltage and a low-voltage side voltage are applied through a high-voltage side selection switch selected from the high-voltage side switch block and a low-voltage side selection switch selected from the low-voltage side switch block, respectively; and a plurality of intermediate voltage takeout signal lines which take out a first intermediate voltage from an end point, connected to the high-voltage side selection switch, of the ladder resistor and which then take out a second and a third, . . . and (k−1)th intermediate voltage from any other end points thereof in the order of closeness to the high-voltage side selection switch and which take out a kth intermediate voltage from an end point, connected to the low-voltage side selection switch, of the ladder resistor, where k is an integer greater than or equal to 2, wherein a dividing resistance value which causes a difference between the (k−1)th intermediate voltage and the kth intermediate voltage among resistance components in the ladder resistor is greater than an on-resistance value of the high-voltage side selection switch.

Similarly, an on-resistance value of the low-voltage side selection switch is made smaller than a low-voltage side dividing resistance value among the ladder resistors, so that the color of pixels can be controlled smoothly.

Still another preferred embodiment according to the present invention relates also to a signal line drive circuit. This circuit includes: a high-voltage side switch block and a low-voltage side switch block; a ladder resistor across which a high-voltage side voltage and a low-voltage side voltage are applied through a high-voltage side selection switch selected from the high-voltage side switch block and a low-voltage side selection switch selected from the low-voltage side switch block, respectively; and a plurality of intermediate voltage takeout signal lines which take out different intermediate voltages, respectively, from any end points of the ladder resistor, wherein the signal line drive circuit is structured such that a relationship of a potential difference between the high-voltage side voltage and a predetermined reference voltage and that between the low-voltage side voltage and the reference voltage and a relationship of on-resistance values of the high-voltage side and low-voltage side-switches are reversed.

Each of switches in the switch block is connected to each different voltage line. The higher the voltage this voltage line supplies, the more time it will take to write the voltage to the signal line. Thus, a predetermined reference voltage (hereinafter referred to as “precharge voltage”) may be supplied beforehand to the signal line at the time the voltage is to be supplied from these voltage lines to the signal lines. For example, a voltage equivalent to the difference between the precharge voltage and a high voltage supplied to the signal line is applied, whereas the precharge voltage is discharged according to the difference if the voltage supplied to the signal line is lower than the precharge voltage. Even though this scheme is adopted, the writing thereof still takes time if the difference between this precharge voltage and the voltage supplied to the signal line is very large. Thus, the on-resistance value of a switch connected to a voltage line that supplies voltage whose potential difference between the precharge voltage and the high voltage is adjusted to a smaller value, so as to reduce the writing time.

Moreover, the circuit may include: an upper selection circuit which receives an input of x bits out of n-bit image signals and selects the high-voltage side selection switch and the low-voltage side selection switch from the high-voltage side switch block and the low-voltage side switch block, respectively, where n is an integer greater than or equal to 2 and x is an integer greater than or equal to 1 and less than n; and a lower selection circuit which selects a desired intermediate voltage takeout signal line from the plurality of intermediate voltage takeout signal lines by signals of (n−x) bits, excluding the x bits, among the image signals.

In this manner, the number of bits of an image signal is appropriately allocated among the upper selection circuit and the lower selection circuit. Thus, the signal line drive circuit can be efficiently designed according to specifications of an image display apparatus.

Moreover, the upper selection circuit may be such that logic to select the high-voltage side selection switch and the low-voltage selection switch exists outside the path of lines on which a plurality of switches included in the switch blocks are interposed, and the lower selection circuit may be such that at least part of logic to select a desired one of the plurality of intermediate voltage takeout signal lines is interposed on the path of the plurality of intermediate voltage takeout signal lines.

In this manner, the type of the circuits in the upper selection circuit is made to differ from that of the circuits in the lower selection circuit. Thus, the signal line drive circuit can be further efficiently designed according to specifications of an image display apparatus.

It is to be noted that any arbitrary combination or rearrangement of the above-described structural components and expressions changed to methods and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a structure of an image display apparatus.

FIG. 2 shows an internal structure of a signal line drive circuit according to an embodiment of the present invention.

FIG. 3 shows an internal structure of an image signal D-A conversion unit shown in FIG. 2.

FIG. 4 shows the levels of pixel applied voltages in the signal line drive circuit shown in FIG. 3.

FIG. 5 shows a general relationship between the light transmittance of liquid crystals and applied voltage in a normally white mode.

FIG. 6 shows an external logic type D-A conversion circuit.

FIG. 7 shows an internal logic type D-A conversion circuit.

FIG. 8 is a schematic diagram showing how pixel applied voltages are taken out of a ladder applied voltage when the on-resistance of switches in a signal line drive circuit is not taken into account.

FIG. 9 is a schematic diagram showing how pixel applied voltages are taken out of a ladder applied voltage when the on-resistance of switches in a signal line drive circuit is taken into account.

FIG. 10 shows a circuit covering from reference gradation voltage lines to image signal lines, according to an embodiment of the present invention.

FIG. 11 shows the levels of pixel voltages after the adjustment of on-resistance values of the switches based on the first relationship, according to an embodiment of the present invention.

FIG. 12 shows the levels of pixel voltages after the adjustment of on-resistance values of the switches based on the second relationship, according to an embodiment of the present invention.

FIG. 13 shows an example of a pixel circuit using organic electroluminescent material.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

First, the operating principle of active matrix type liquid crystal display apparatus will be described hereinbelow.

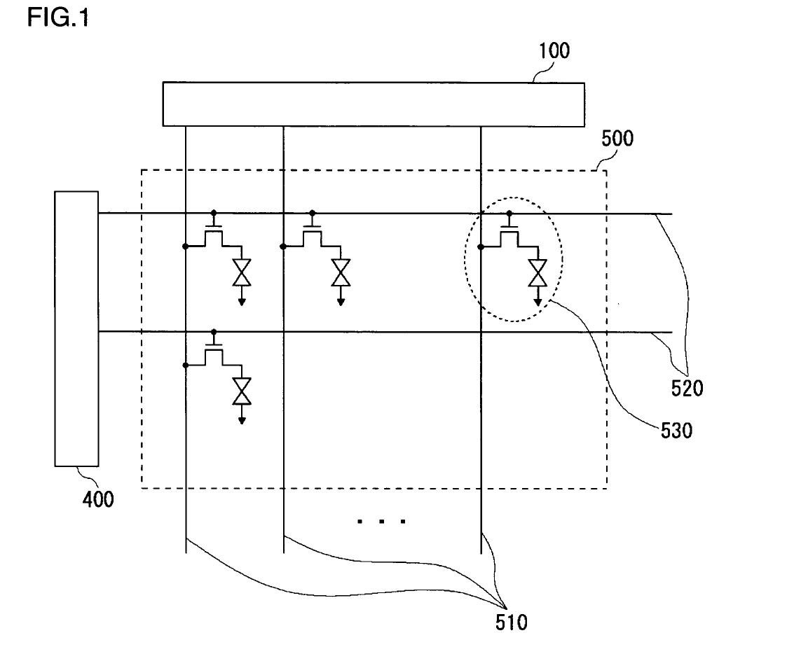

FIG. 1 shows a structure of an active matrix liquid crystal display apparatus. The active matrix liquid crystal display apparatus includes a signal line drive circuit 100, a scanning line drive circuit 400 and a pixel matrix 500. The signal line drive circuit 100 samples inputted image signals in synchronism with timing signals, such as clock signals. Then the signal line drive circuit 100 converts the sampled image signals into predetermined corresponding voltages and apply them to the respective pixel circuits 530 on the respective pixel signal lines 510. The scanning line drive circuit 400 sequentially selects scanning lines 520 in synchronism with timing signals, such as clock signals, and performs on-off control of the respective pixel circuits 530 on the respective scanning lines 520. And desired image display is produced as the liquid crystals in the pixel circuits 530 change the light transmittance according to the applied voltages.

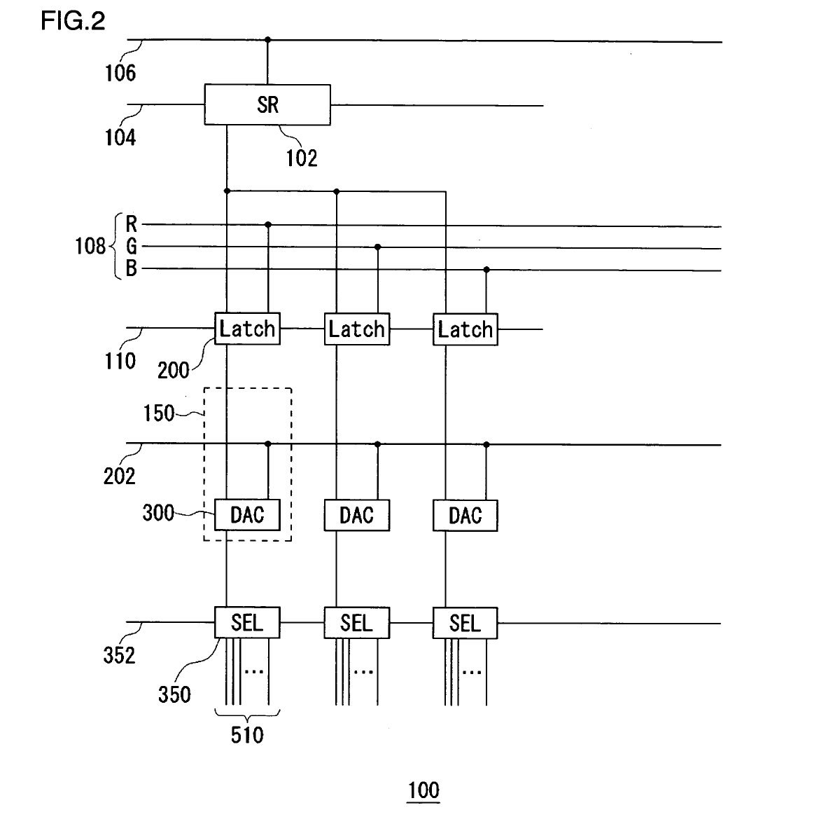

FIG. 2 shows an internal structure of the signal line drive circuit 100. Upon receipt of a start pulse from a start pulse signal line 104, a shift register 102 produces a sampling pulse in synchronism with a clock signal inputted from a clock signal line 106. In synchronism with this sampling pulse, a latch circuit 200 receives a digital image signal (hereinafter referred to simply as “image signal”) from an image signal line 108 and stores this digital image signal.

The image signal stored in the latch circuit 200 is delivered to an image signal D-A conversion circuit 300 in synchronism with a latch signal inputted from a latch signal line 110. Based on a voltage supplied from a reference gradation voltage line 202 (hereinafter referred to as “reference gradation voltage”), the image signal D-A conversion circuit 300 converts this image signal into a predetermined voltage (hereinafter referred to as “pixel applied voltage”). The mechanism of D-A conversion by the image signal D-A conversion circuit 300 will be described in detail later.

Upon receipt of the input of a pixel applied voltage from the image signal D-A conversion circuit 300, a pixel signal line selection circuit 350 applies the pixel applied voltage to a predetermined pixel signal line 510 in synchronism with a signal line selection signal inputted from a pixel signal line selection signal line 352. The pixel signal line selection circuit 350 drives all the pixel signal lines 510 by writing data in a manner such that a scanning line period is divided into a plurality of divisions. That is, with the pixel signal line selection circuit 350, a plurality of pixel signal lines are driven by a single D-A conversion circuit 300. Thus, the circuit area can be significantly reduced.

Next, the operating principle of an image signal D-A conversion unit 150 shown in FIG. 2 will be described hereinbelow.

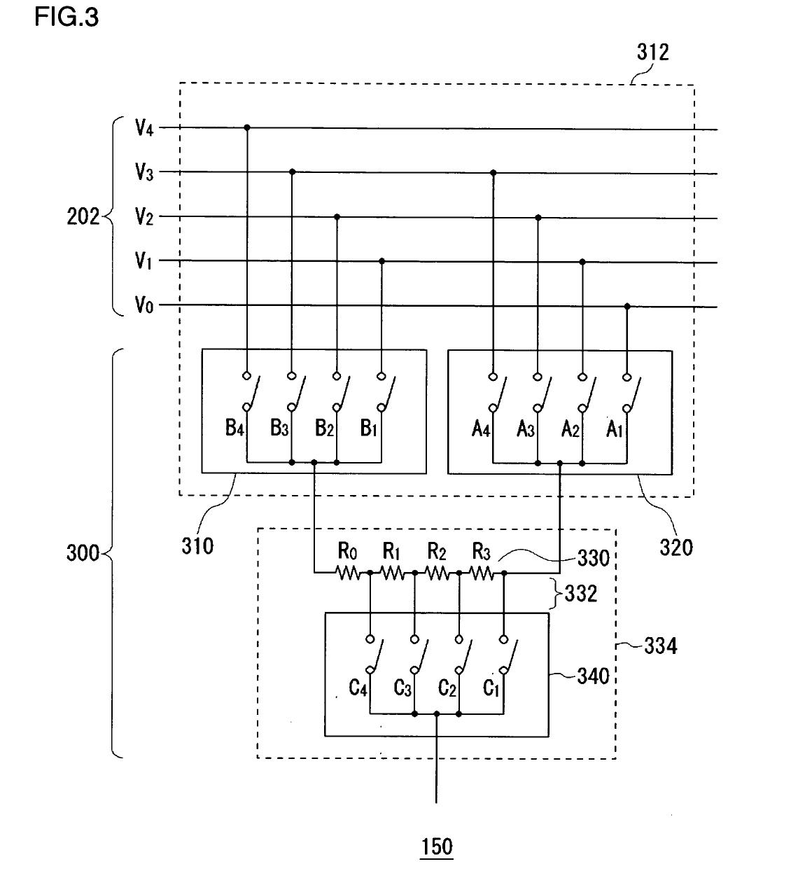

FIG. 3 shows an internal structure of the image signal D-A conversion unit 150 shown in FIG. 2. Here, the case of a 4-bit image signal D-A conversion unit 150 will be described by way of example. In what follows, however, no consideration is given to the internal resistance of wiring itself or the on-resistance of the switches.

The image signal D-A conversion unit 150 can be divided into an upper selection circuit 312 and a lower selection circuit 334. The upper selection circuit 312 includes a high-voltage side switch block 310 having four switches (B₁ to B₄), a low-voltage side switch block 320 having four switches (A₁ to A₄), and reference gradation voltage lines 202. The lower selection circuit 334 includes a ladder switch block 340 having four switches (C₁ to C₄) and ladder resistors 330. The reference gradation voltage lines 202 supply five levels of voltage (V₀ to V₄) from low to high voltage, respectively.

Referring to FIG. 3, the high-voltage side switch block 310 and the low-voltage side switch block 320 are each controlled by the two bits of signal (hereinafter referred to as “upper order signal”) of the four bits of image signal sent from the latch circuit 200. The high-voltage side switch block 310 and the low-voltage side switch block 320 are each so designed that any one of the switches is ON but no two switches are ON simultaneously. Moreover, the switches inside the high-voltage side switch block 310 and those inside the low-voltage side switch block 320 have predetermined relationships as described below.

That is, when the B₄ switch of the high-voltage side switch block 310 turns on, the A₄ switch of the low-voltage side switch block 320 also turns on in linkage therewith. In a similar manner, when the B₃ switch of the high-voltage side switch block 310 turns on, the A₃ switch of the low-voltage side switch block 320 also turns on in linkage therewith. The same thing applies to the other switches as well. Accordingly, a neighboring pair of reference gradation voltage lines 202 is always selected, and a predetermined reference gradation voltage is applied across the ladder resistor 330.

The ladder switch block 340 is controlled by the remaining two bits of signal (hereinafter referred to as “lower order signal”) of the four bits of image signal sent from the latch circuit 200 after the use of the other two bits by the upper selection circuit 312. The ladder switch block 340 is so designed that any one of the switches is ON but no two switches are ON simultaneously.

The voltage (hereinafter referred to as “ladder applied voltage”) selected by the upper selection circuit 312 and applied across the ladder resistor 330 is divided by dividing resistances R₀ to R₃ of the ladder resistor 330. Then four kinds of intermediate voltages are inputted to the ladder switch block 340 through four intermediate voltage takeout signal lines 332. Hence, with one of the switches in the ladder switch block 340 ON according to the lower order signal, a corresponding one of these intermediate voltages is outputted as a pixel applied voltage to the pixel signal line selection circuit 350 shown in FIG. 2.

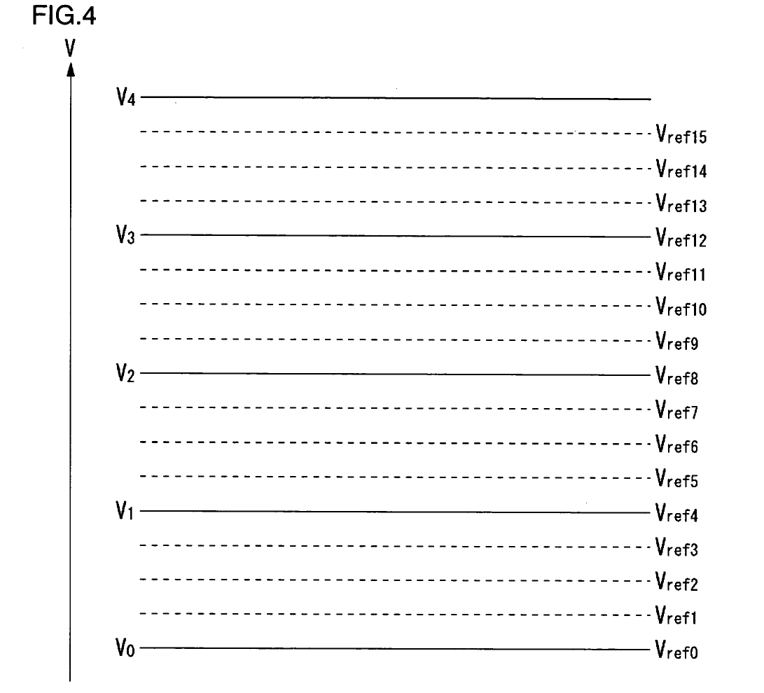

FIG. 4 shows the levels of pixel applied voltages outputted by the lower selection circuit 334. The image signal D-A conversion unit 150 outputs 16 kinds of pixel voltages, V_{ref0} to V_{ref15}, through four-bit image signals. For example, when the switch A₁ of the low-voltage side switch block 320 and the switch B₁ of the high-voltage side switch block 310 are turned on, the ladder voltage becomes V₁-V₀.

When the switch C₁ of the ladder switch block 340 is selected, the lower selection circuit 334 outputs V₀, which is the pixel applied voltage V_{ref0} shown in FIG. 4. When the switch C₂, not the switch C₁, of the ladder switch block 340 is selected, the lower selection circuit 334 outputs the pixel applied voltage V_{ref1}, which is a voltage higher than V₀ by as much as the dividing resistance R₃. The same applies to the other switches thereof, and when the switch A₄ of the low-voltage side switch block 320, the switch B₄ of the high-voltage side switch block 310 and the switch C₄ of the ladder switch block 340 are turned on, the lower selection circuit 334 outputs the pixel applied voltage V_{ref15}, which is the voltage of V₄ minus the voltage drop caused by the dividing resistance R₀ of the ladder resistor 330.

The dividing resistance R₀ is provided in the ladder resistance 330 so as not to create a state in which the lower selection circuit 334 consequently outputs the same pixel voltage for different combinations of switch selection in the high-voltage side switch block 310, the low-voltage side switch block 320 and the ladder switch block 340.

Suppose that the dividing resistance R₀ is not provided. Now, when the switch A₃ of the low-voltage side switch block 320, the switch B₃ of the high-voltage side switch block 310 and the switch C₄ of the ladder switch block 340 are selected, then the lower selection circuit 334 will output V₃ as a pixel applied voltage. If the switch A₄ of the low-voltage side switch block 320, the switch B₄ of the high-voltage side switch block 310 and the switch C₁ of the ladder switch block 340 are selected, then the lower selection circuit 334 will output the same V₃ as a pixel applied voltage. In other words, there are cases where the same pixel applied voltage can be outputted for different combinations of switch selection in the respective switch blocks.

However, with the dividing resistance R₀ present, the lower selection circuit 334, in the former case, will output a pixel applied voltage which is the reference gradation voltage V₃ minus a voltage equivalent to the voltage drop caused by the dividing resistance R₀, thus avoiding the above-mentioned problem. That is, the image signal D-A conversion unit 150 can output 16 kinds of pixel applied voltages according to four-bit image signals thanks to the provision of the dividing resistance R₀.

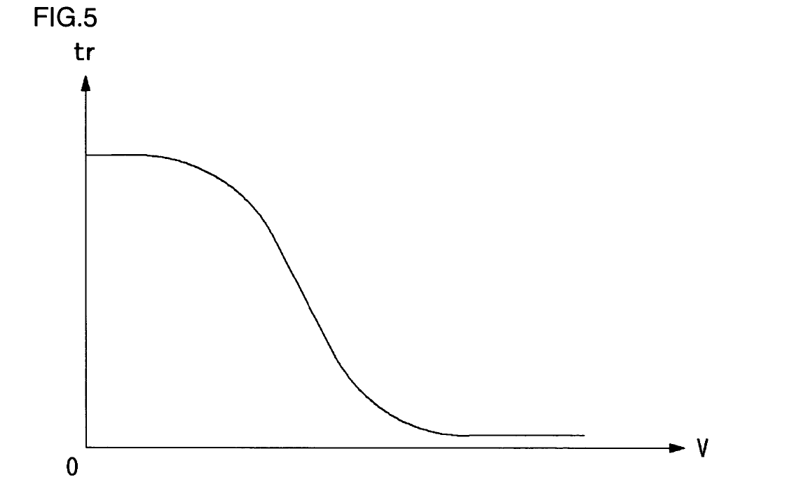

FIG. 5 shows a general relationship between the light transmittance of liquid crystals and applied voltage in a white display mode (hereinafter referred to as “normally white mode”) where voltage is not applied. The horizontal axis of the graph represents applied voltage, and the vertical axis represents light transmittance. As is apparent from FIG. 5, the larger the applied voltage, the lower transmittance of light the liquid crystal shows. Hence, desired image display can be achieved by controlling the pixel applied voltage to be outputted from the image signal D-A conversion unit 150.

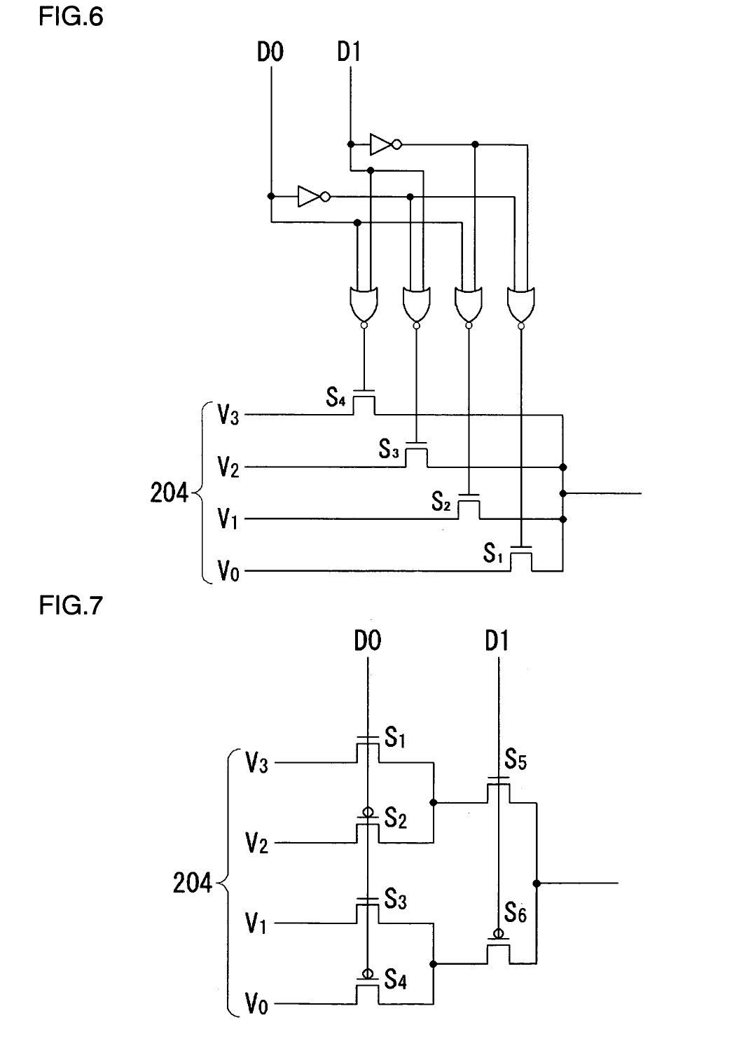

Now the circuit structure of the high-voltage side switch block 310, the low-voltage side switch block 320 and the ladder switch block 340 as shown in FIG. 3 will be explained. There are two types of structuring these circuits as illustrated in FIGS. 6 and 7. Here the description concerns two-bit circuits by way of example. And all the switches are assumed to be TFTs.

FIG. 6 shows an example of a D-A conversion circuit controlled by two-bit signals D0 and D1. Hereinbelow, a circuit for which logic to select switches exists outside the path of lines on which a plurality of switches are interposed, like this circuit, is referred to as “an external logic type circuit.”

Voltage supply lines 204 supply four kinds of voltage, V₀ to V₃, respectively. In the external logic type circuit shown in FIG. 6, one of the switching TFTs, S₁ to S₄, is selected by four NOR gates and two inverters according to two-bit signals (D0, D1). Thus one of the four voltages, V₀ to V₃, is supplied and a D-A conversion is realized. For example, if D0 is high and D1 is low, then S₃ only will turn on, and therefore voltage V₂ will be outputted from this circuit.

FIG. 7 shows another example of a D-A conversion circuit controlled by two-bit signals D0 and D1. Hereinbelow, a circuit for which at least part of the logic to select a desired one of a plurality of lines is interposed on the path of the line to be selected, like this circuit, is referred to as “an internal logic type circuit.”

Voltage supply lines 204 supply four kinds of voltage, V₀ to V₃, respectively. In the internal logic type circuit shown in FIG. 7, the six switching TFTs, S₁ to S₆, interposed on the voltage supply lines 204 are selected appropriately according to two-bit signals D0 and D1. Thus one of the four voltages, V₀ to V₃, is outputted and a D-A conversion is realized. For example, if D0 is high and D1 is low, then switching TFTs S₁, S₃ and S₆ will turn on, so that voltage V₁ will be outputted from this circuit.

In the external logic type circuit shown in FIG. 6, voltage is taken out of the voltage supply lines 204 through only one of the switching TFTs S₁ to S₄. Hence, the external logic type circuit shows an excellent drive performance with the voltage drop relatively small because of the passage of voltage through only one switching TFT.

On the other hand, the internal logic type circuit shown in FIG. 7 proves useful and advantageous in reducing the scale of the circuit because the logic can be organized with only six TFTs for two-bit signals.

Hereinbelow, a detailed description will be given of problems that may arise when no corrective measures are taken against the voltage drop to be caused by the on-resistance of these switches.

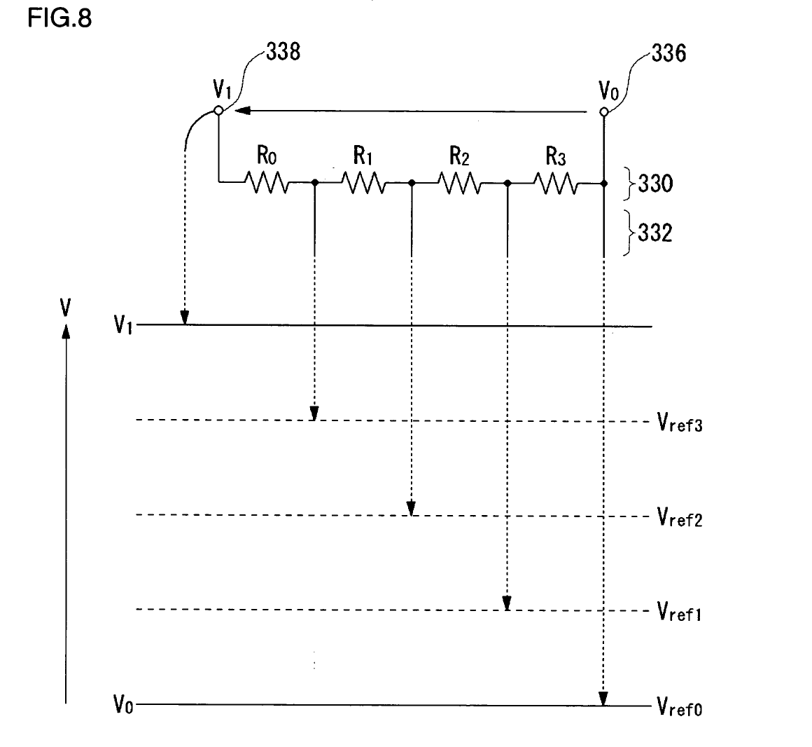

FIG. 8 is a schematic diagram showing how pixel applied voltages are taken out of a ladder applied voltage. Here it is assumed that there is no on-resistance of switches in the high-voltage side switch block 310, the low-voltage side switch block 320 and the ladder switch block 340 shown in FIG. 3.

In FIG. 8, the reference gradation voltages selected by the low-voltage side switch block 320 and the high-voltage side switch block 310 are applied to a low-voltage side ladder resistance end point 336 and a high-voltage side ladder resistance end point 338, respectively. Here it is assumed that the reference gradation voltage V₁ is applied to the high-voltage side ladder resistance end point 338, and the reference gradation voltage V₀ is applied to the low-voltage side ladder resistance end point 336.

As aforementioned, a ladder voltage is divided by the dividing resistances R₀ to R₃, and intermediate voltages are taken out by the intermediate voltage takeout signal lines 332. In FIG. 8, voltages V_{ref0} to V_{ref3} are taken out by the four intermediate voltage takeout signal lines 332. Accordingly, it is possible that arbitrary pixel applied voltage between V₀ and V₁ be eventually taken out by adjusting the values of dividing resistances R₀ to R₃.

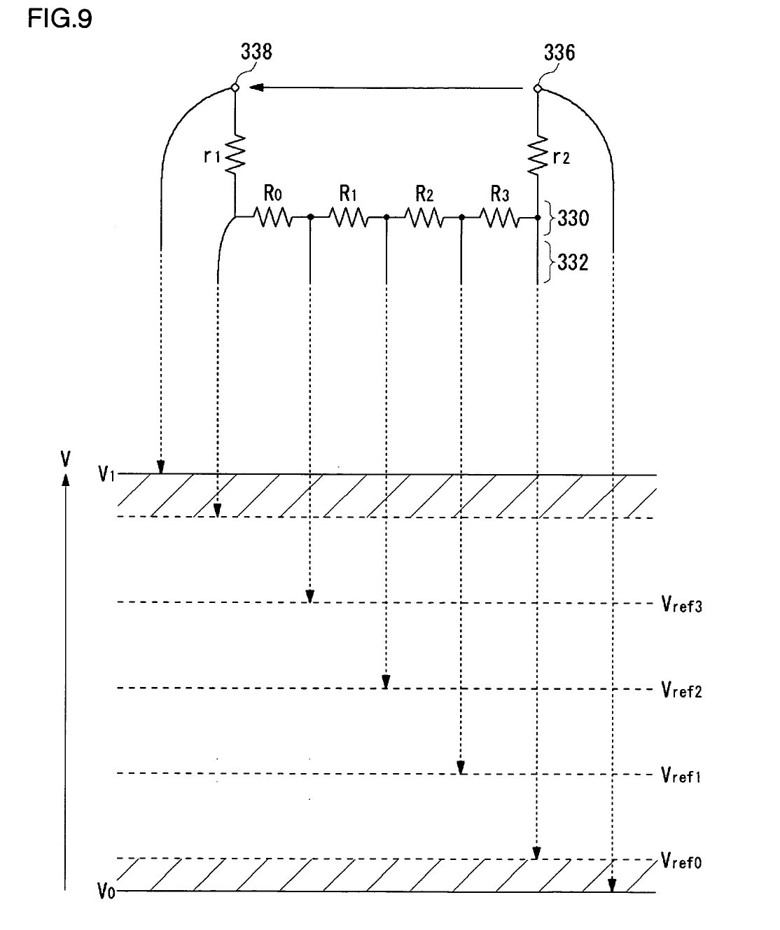

FIG. 9 is also a schematic diagram showing how pixel applied voltages are taken out of a ladder voltage. In this case shown in FIG. 9, the on-resistance of switches in the high-voltage side switch block 310 and the low-voltage side switch block 320 shown in FIG. 3 is taken into consideration although that in the ladder switch block 340 is not.

In FIG. 9, the reference gradation voltages selected by the low-voltage side switch block 320 and the high-voltage side switch block 310 are applied to the low-voltage side ladder resistance end point 336 and the high-voltage side ladder resistance end point 338, respectively. Here it is also assumed that the reference gradation voltage V₁ is applied to the high-voltage side ladder resistance end point 338, and the reference gradation voltage V₀ to the low-voltage side ladder resistance end point 336.

Here, resistances r₁ and r₂ are the on-resistances of switches selected by the high-voltage side switch block 310 and the low-voltage side switch block 320, respectively. Hence, due to the voltage drop caused by these on-resistances, voltage supply across the ladder resistance 330 is actually not in a range of V₁ to V₀ but in a range narrower than that. Namely, voltage within certain ranges cannot be supplied as pixel applied voltage even when the resistance values of the dividing resistance R₀ to R₃ are adjusted. These ranges are the parts shaded with oblique lines in FIG. 9. Hereinbelow, the ranges of voltage that cannot be supplied due to voltage drops caused by the on-resistances will be referred to as “unsuppliable voltage ranges.”

The unsuppliable voltage ranges are the ranges of voltage that cannot be applied to the liquid crystals. They naturally pose an obstacle to controlling the colors of an image display apparatus smoothly., The obstacle will be especially serious if there are multiple stages of switches connected for the voltage supply.

Hereinafter, the specific embodiments according to the present invention will be described to solve such problems.

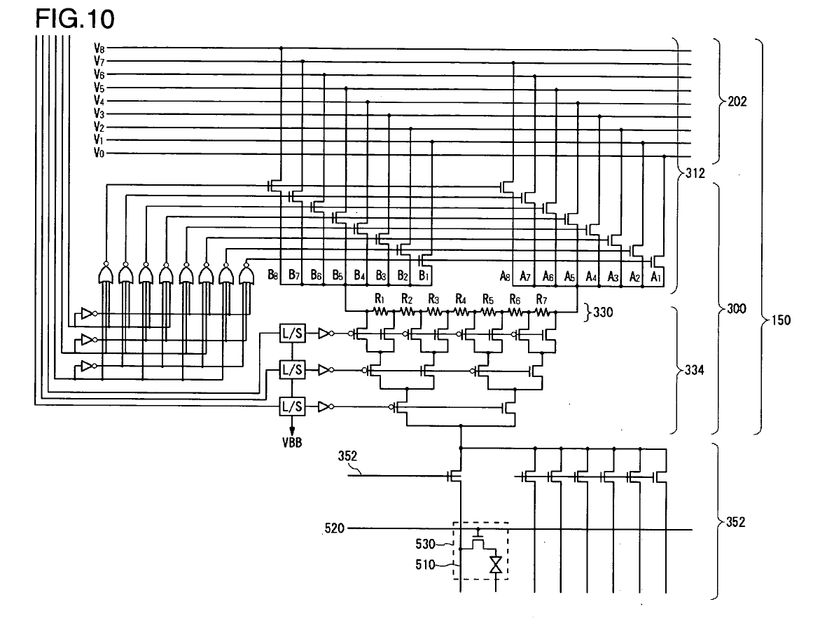

FIG. 10 shows an embodiment of the present invention wherein reference gradation voltage lines 202, an image signal D-A conversion circuit 300 and pixel signal line selection signal lines 352 are driven by six-bit image signals. In FIG. 10, three bits of a 6-bit image signal are used as upper order signals, and the remaining three bits thereof as lower order signals.

In FIG. 10, an upper selection circuit 312 is formed by an external logic type circuit, and a lower selection circuit 334 is formed by an internal logic type circuit. Reference gradation voltage lines 202 supply nine kinds of reference gradation voltages V₀ to V₈. Corresponding thereto, the high-voltage side and low-voltage side switch blocks of the upper selection circuit 312 include eight each of the switches B₁ to B₈ and A₁ to A₈, respectively. The ladder resistance 330 is divided into seven parts by the dividing resistances R₁ to R₇, and the lower selection circuit 334 receives eight kinds of intermediate voltage as inputs.

In FIG. 10, the on-resistance values of the switches in the upper selection circuit 312 are adjusted appropriately. The adjustment method therefor will be described in detail later. In this structure shown in FIG. 10, however, a resistance, which corresponds to the dividing resistance R₀ of FIG. 3, is not provided. This is because, as will be explained later, proper adjustment and control of the on-resistances of the switches in the upper selection circuit 312, even without the dividing resistance R₀, will prevent the creation of any condition where the same pixel applied voltage can be consequently outputted for the selection of different switches by the image signal D-A conversion circuit 300.

The adjustment and control of on-resistance values of the switches is carried out from two viewpoints. One is the relationship between the dividing resistance values of the ladder resistance and the on-resistance values of the switches (hereinafter referred to as “first relationship”). And the other is the relationship between the reference gradation voltages of the respective reference gradation voltage lines 202 to which the switches are connected and the on-resistance values thereof (hereinafter referred to as “second relationship”). It is to be noted here that when the switches are TFTs, the adjustment and control of the on-resistance values of the switches can be carried out by adjusting the gate width and gate length of the TFTs.

First relationship:

In this circuit, the on-resistance value of each of the switches B_{1 to B}₈ in the high-voltage side switch block 310 is set smaller than the resistance value of the dividing resistance R₁. By way of numerical examples, the gate width of the TFTs is set to 300 μm, the gate length thereof to 4 μm and thus the on-resistance value thereof is set to 1.5 kΩ, whereas the resistance value of the dividing resistance R₁ is set to 3 kΩ. Similarly, the on-resistance values of the switches A₁ to A₈ of the low-voltage side switch block 320 are set smaller than the resistance value of the dividing resistance R₇.

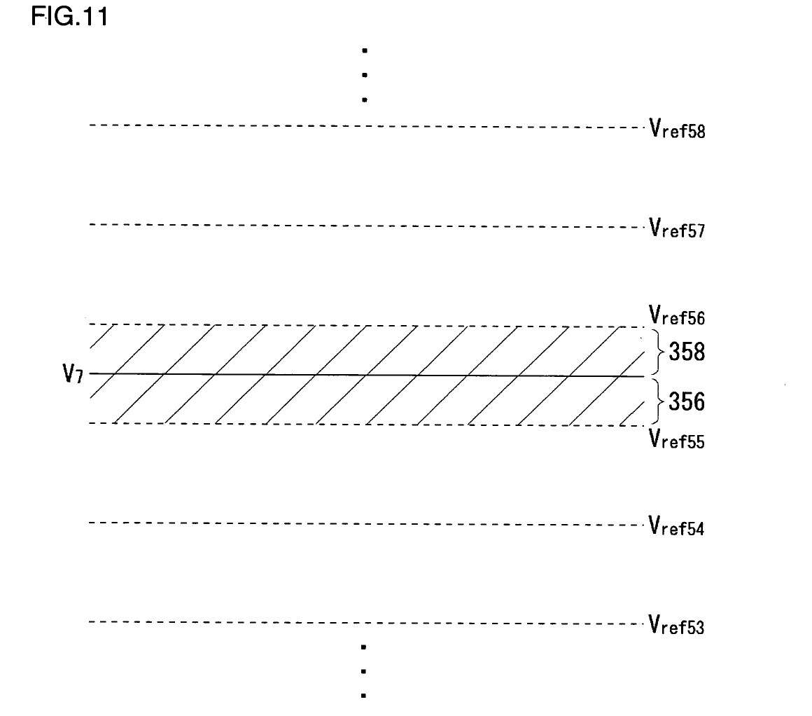

FIG. 11 shows the levels of pixel voltages after the adjustment of the on-resistance values of the switches based on the first relationship. For the simplicity of explaining the operating principle in FIG. 11, however, attention is directed only to the on-resistances of the switches A₁ to A₈ and B₁ to B₈ in the upper selection circuit 312 and no consideration is given to the on-resistances of the switches in the lower selection circuit 334.

FIG. 11 shows the levels of voltage near the reference gradation voltage V₇ of the reference gradation voltage line 202, among the pixel applied voltages to be outputted by the lower selection circuit 334. The voltage drop 356 in FIG. 11 represents the voltage drop caused by the on-resistance of the switch B₇ when switches B₇ and A₇ are being selected by the upper selection circuit 312. And the potential difference between V_{ref55} and V_{ref54} results from the voltage that applies to the dividing resistance R₁ at this time. Therefore, if, for instance, the on-resistance value of the switch B₇ is half the resistance value of the dividing resistance R₁, then the potential difference between V_{ref55} and V_{ref54} will be twice that between V₇ and V_{ref55} (that is, V_{ref55}−V_{ref54}=2 (V₇−V_{ref55}))

In a similar manner, the voltage drop 358 in FIG. 11 represents the voltage drop caused by the switch A₈ when switches B₈ and A₈ are being selected by the upper selection circuit 312. And the potential difference between V_{ref57} and V_{ref56} results from the voltage that applies across the dividing resistance R₇ at this time. Therefore, if the on-resistance value of the switch A₈ is half the resistance value of the dividing resistance R₇, then the potential difference between V_{ref57} and V_{ref56} will be twice that between V_{ref56} and V₇ (that is V_{ref57}−V_{ref56}=2 (V_{ref56}−V₇))

The adjustment and control based on the first relationship thus realizes smooth transition between voltage levels by adjusting the unsuppliable voltage ranges that exist between V_{ref54} and V_{ref57}. This, of course, is not limited to the case where the on-resistance value of a given switch becomes half the resistance value of a given dividing resistance as described above.

Second relationship:

Generally, the higher the voltage, the more time it will take to write it. And the writing time can be shortened by setting a smaller on-resistance value for the switch that conducts the high voltage. This is because the small on-resistance value of the switch raises the drive performance thereof. By way of example, a case where the reference gradation voltages V₈ and V₇ are applied to the respective ends of the ladder resistance 330 will be described hereinbelow.

In this case, the reference gradation voltage V₈ takes more time for writing the voltage than the reference gradation voltage V₇. Hence, the on-resistance value of the switch B₈ connected to the reference gradation voltage V₈ is set smaller than the on-resistance value of the switch A₈ connected to the reference gradation voltage V₇. As a numerical example, the on-resistance value of the switch B₈ is set to 0.33 times the dividing resistance value, and that of the switch A₈ is set to 0.67 times the dividing resistance value, on the assumption that the dividing resistances R₁ to R₇ of the ladder resistance 330 have all the same resistance value.

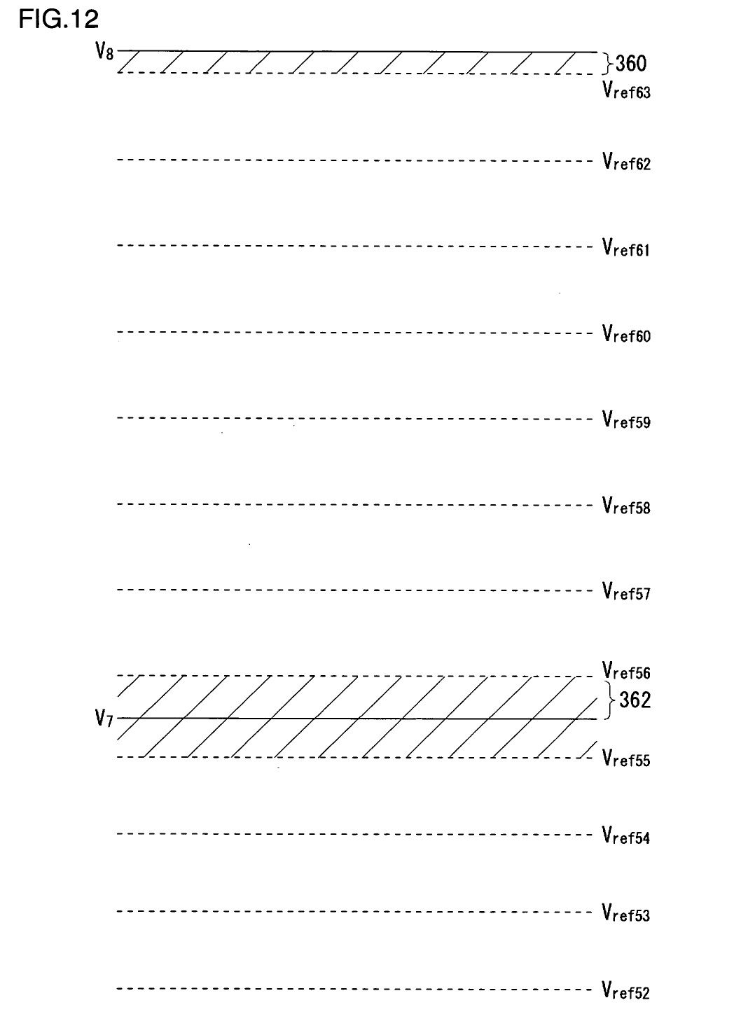

FIG. 12 shows the levels of pixel voltages after the adjustment of the on-resistance values of the switches based on the second relationship. For the simplicity of explaining the operating principle in FIG. 12, however, attention is directed only to the on-resistances of the switches A₁ to A₈ and B₁ to B₈ in the upper selection circuit 312 and no consideration is given to the on-resistances of the switches in the lower selection circuit 334.

FIG. 12 shows the levels of voltage near the reference gradation voltages V₇ to V₈ of the reference gradation voltage lines 202, among the pixel voltages to be outputted by the lower selection circuit 334. The voltage drop 360 in FIG. 12 represents the voltage drop caused by the on-resistance of the switch B₈ when switches B₈ and A₈ are being selected by the upper selection circuit 312. Likewise, the voltage drop 362 represents the voltage drop caused by the switch A₈. Since a high voltage is supplied thereto, the on-resistance value of the switch B₈ is set smaller than the on-resistance value of the switch A₈.

The adjustment and control based on the second relationship can shorten the time for the signal line drive circuit 100 to write given voltages to the pixel signal lines 510. Where the aforementioned precharge voltage is applied to the signal lines beforehand, it will be necessary to perform a discharge when the voltage to be actually supplied to the signal line is smaller than the precharge voltage. Hence, even when a switch conducts a low voltage, the switch may take a longer time for the drive operation if there is a large potential difference between the voltage to be conducted by the switch and the precharge voltage. Therefore, in this case, too, the voltage writing time can be shortened by setting a smaller on-resistance value for the switch conducting the low voltage. Moreover, it is also possible to expand the dynamic range (potential difference between V_{ref63} and V_{ref0}) by setting the on-resistance values of switches A₁ and B₈ smaller than those of the other switches.

As described above, the internal logic type circuit, which may have a reduced number of TFT elements, is advantageous in its capacity to reduce the circuit area. The external logic type circuit, on the other hand, excels in its circuit responsiveness because it allows the takeout of voltage through only one stage of switching TFT, which results in a smaller voltage drop.

In the embodiment of the present invention shown in FIG. 11, the upper selection circuit 312 is formed by an external logic type circuit, whereas the lower selection circuit 334 is formed by an internal logic type circuit. Hence, when the bits of an image signal are divided into an upper order signal and a lower order signal, a trade-off may be achieved between the reduction in circuit area and the shortening of write time. In other words, if priority is to be given to the response speed of an image display apparatus, a circuit may be designed such that more bits may be given to the external logic type circuit by reducing the stages of switches between the reference gradation voltage lines 202 and the pixel signal line selection signal lines 352. Conversely, if the reduction of circuit area is preferred, more bits should be allocated to the internal logic type circuit.

The present invention has been described based on the embodiments which are only exemplary. It is understood by those skilled in the art that there exist other various modifications to the combination of each component described above and that such modifications are encompassed by the scope of the present invention.

As an example of such modifications, a case where electroluminescent (hereinafter simply referred to as “EL”) material is used as display elements will be described. The circuit structure for EL elements, which are of current-driven type, differs from the pixel circuit 530 for the liquid crystal material.

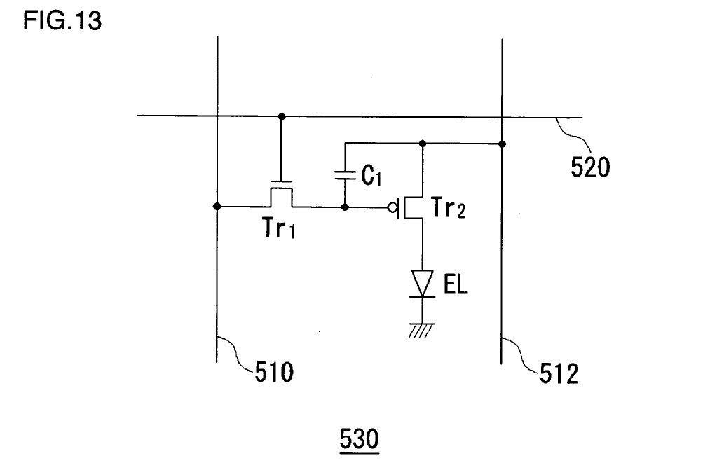

FIG. 13 shows an example of a pixel circuit 530 using EL material. The pixel circuit 530 in FIG. 13 includes two TFTs, namely, a switching transistor Tr₁ which specifies write timing and a drive transistor Tr₂ that delivers current to the EL element. Further, the pixel circuit 530 includes a capacitor C₁ for holding write voltage, a scanning line 520, a pixel signal line 510, and a power line 512 for supplying power.

In the pixel circuit 530 shown in FIG. 13, at the selection of the scanning line 520, the switching transistor Tr₁ turns on and the voltage on the pixel signal line 510 is stored in the capacitor C₁. At the same time, the drive transistor Tr₂ also turns on, and a current corresponding to the write voltage flows to the EL element, thus causing the EL element to illuminate. Even after the period during which the scanning line 520 is being selected, the voltage held in the capacitor C1 causes a predetermined current to flow to the EL element until a next image signal is received.

Although the present invention has been described by way of exemplary embodiments, it should be understood that many changes and substitutions may further be made by those skilled in the art without departing from the scope of the present invention which is defined by the appended claims.

What is claimed is:

1. A signal line drive circuit, including:
a high-voltage side switch block and a low-voltage side switch block;
a ladder resistor across which a high-voltage side voltage and a low-voltage side voltage are applied through a high-voltage side selection switch selected from said high-voltage side switch block and a low-voltage side selection switch selected from said low-voltage side switch block, respectively; and
a plurality of intermediate voltage takeout signal lines which take out a first intermediate voltage from an end point, connected to the high-voltage side selection switch, of said ladder resistor and which then take out a second and a third, . . . and (k−1)th intermediate voltage from any other end points thereof in the order of closeness to the high-voltage side selection switch and which take out a kth intermediate voltage from an end point, connected to the low-voltage side selection switch, of said ladder resistor, where k is an integer greater than or equal to 2,
wherein a dividing resistance value which causes a difference between the first intermediate voltage and the second intermediate voltage among resistance components in said ladder resistor is greater than an on-resistance value of the high-voltage side selection switch.

2. A signal line drive circuit, including:
a high-voltage side switch block and a low-voltage side switch block;
a ladder resistor across which a high-voltage side voltage and a low-voltage side voltage are applied through a high-voltage side selection switch selected from said high-voltage side switch block and a low-voltage side selection switch selected from said low-voltage side switch block, respectively; and
a plurality of intermediate voltage takeout signal lines which take out a first intermediate voltage from an end point, connected to the high-voltage side selection switch, of said ladder resistor and which then take out a second and a third, . . . and (k−1)th intermediate voltage from any other end points thereof in the order of closeness to the high-voltage side selection switch and which take out a kth intermediate voltage from an end point, connected to the low-voltage side selection switch, of said ladder resistor, where k is an integer greater than or equal to 2,
wherein a dividing resistance value which causes a difference between the (k−1)th intermediate voltage and the kth intermediate voltage among resistance components in said ladder resistor is greater than an on-resistance value of the high-voltage side selection switch.

3. A signal line drive circuit, including:
a high-voltage side switch block and a low-voltage side switch block;
a ladder resistor across which a high-voltage side voltage and a low-voltage side voltage are applied through a high-voltage side selection switch selected from said high-voltage side switch block and a low-voltage side selection switch selected from said low-voltage side switch block, respectively; and
a plurality of intermediate voltage takeout signal lines which take out different intermediate voltages, respectively, from any end points of said ladder resistor,
wherein the signal line drive circuit is structured such that a relationship of a potential difference between the high-voltage side voltage and a predetermined reference voltage and that between the low-voltage side voltage and the reference voltage and a relationship of on-resistance values of said high-voltage side and low-voltage side switches are reversed.

4. A signal line drive circuit according to claim 1, including:
an upper selection circuit which receives an input of x bits out of n-bit image signals and selects the high-voltage side selection switch and the low-voltage side selection switch from said high-voltage side switch block and said low-voltage side switch block, respectively, where n is an integer greater than or equal to 2 and x is an integer greater than or equal to 1 and less than n; and
a lower selection circuit which selects a desired intermediate voltage takeout signal line from said plurality of intermediate voltage takeout signal lines by signals of (n-x) bits, excluding the x bits, among the image signals.

5. A signal line drive circuit according to claim 2, including:
an upper selection circuit which receives an input of x bits out of n-bit image signals and selects the high-voltage side selection switch and the low-voltage side selection switch from said high-voltage side switch block and said low-voltage side switch block, respectively, where n is an integer greater than or equal to 2 and x is an integer greater than or equal to 1 and less than n; and
a lower selection circuit which selects a desired intermediate voltage takeout signal line from said plurality of intermediate voltage takeout signal lines by signals of (n−x) bits, excluding the x bits, among the image signals.

6. A signal line drive circuit according to claim 3, including:
an upper selection circuit which receives an input of x bits out of n-bit image signals and selects the high-voltage side selection switch and the low-voltage side selection switch from said high-voltage side switch block and said low-voltage side switch block, respectively, where n is an integer greater than or equal to 2 and x is an integer greater than or equal to land less than n; and
a lower selection circuit which selects a desired intermediate voltage takeout signal line from said plurality of intermediate voltage takeout signal lines by signals of (n-x) bits, excluding the x bits, among the image signals.

7. A signal line drive circuit according to claim 4, wherein said upper selection circuit is such that logic to select the high-voltage side selection switch and the low-voltage selection switch exists outside the path of lines on which a plurality of switches included in said switch blocks is interposed, and wherein said lower selection circuit is such that at least part of logic to select a desired one of said plurality of intermediate voltage takeout signal lines is interposed on the path of said plurality of intermediate voltage takeout signal lines.

8. A signal line drive circuit according to claim 5, wherein said upper selection circuit is such that logic to select the high-voltage side selection switch and the low-voltage selection switch exists outside the path of lines on which a plurality of switches included in said switch blocks are interposed, and wherein said lower selection circuit is such that at least part of logic to select a desired one of said plurality of intermediate voltage takeout signal lines is interposed on the path of said plurality of intermediate voltage takeout signal lines.

9. A signal line drive circuit according to claim 6, wherein said upper selection circuit is such that logic to select the high-voltage side selection switch and the low-voltage selection switch exists outside the path of lines on which a plurality of switches included in said switch blocks are interposed, and wherein said lower selection circuit is such that at least part of logic to select a desired one of said plurality of intermediate voltage takeout signal lines is interposed on the path of said plurality of intermediate voltage takeout signal lines.
